(19) United States
(12) Patent Application Publication
(10) Pub. No.: US 2012/0069753 A1
(43) Pub. Date: Mar. 22, 2012

(54) CHANNEL ESTIMATION BASED ON MIDAMBLE

(75) Inventors: Hari Sankar, San Diego, CA (US); Wenjun Li, San Diego, CA (US); Farrokh Abrishamkar, San Diego, CA (US); Srikanth Gummadi, San Diego, CA (US)

(73) Assignee: QUALCOMM Incorporated, San Diego, CA (US)

(21) Appl. No.: 13/175,279

(22) Filed: Jul. 1, 2011

Related U.S. Application Data
(60) Provisional application No. 61/362,617, filed on Jul. 8, 2010.

(51) Int. Cl. H04W 24/00

(52) U.S. Cl. 370/252

(57) ABSTRACT

Channel estimation at a user equipment includes estimating channel quality of at least one channel. A first algorithm or a second algorithm is selected based on the estimated channel quality. Channel estimation is performed based on the selected algorithm. The first algorithm may be a midamble multiplication-based algorithm. The second algorithm may be a midamble division algorithm. Channel estimation may also include estimating noise of a channel and adaptively setting a threshold based on the estimated noise to refine the channel estimation. The estimating channel quality, selecting of a first or second algorithm and channel estimation may be performed iteratively for contributing signals on a channel. An adaptive threshold may be modified across iterations. The channel estimation may also include determining a delay profile of a channel to refine the channel estimation.

### CROSS REFERENCE TO RELATED APPLICATION

This application claims the benefit of U.S. provisional patent application No. 61/362,617 filed Jul. 8, 2010, in the names of SANKAR et al., the disclosure of which is expressly incorporated herein by reference in its entirety.

### BACKGROUND

1. Field

Aspects of the present disclosure relate generally to wireless communication systems, and more particularly, to linear interference cancellation receivers.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the disclosure, a method of channel estimation includes estimating channel quality of at least one channel and selecting either a first algorithm or a second algorithm based on the estimated channel quality. The method further includes performing channel estimation based on the selected algorithm.

In another aspect of the disclosure, a user equipment configured for channel estimation includes means for estimating the channel quality of at least one channel. The user equipment also includes means for selecting either a first algorithm or a second algorithm based on the estimated channel quality. The user equipment further includes means for performing channel estimation based on the selected algorithm.

In another aspect of the disclosure, a computer program product has a computer readable medium with program code stored thereon. The program code includes code to estimate the channel quality of at least one channel. The program code also includes code to select either a first algorithm or a second algorithm. based on the estimated channel quality. The program code further includes code to perform channel estimation based on the selected algorithm.

In another aspect of the disclosure, a user equipment for wireless communication includes at least one processor and a memory coupled to the processor. The processor is configured to estimate the channel quality of at least one channel. The processor is also configured to select either a first algorithm or a second algorithm. based on the estimated channel quality. The processor is further configured to perform channel estimation based on the selected algorithm.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B in communication with a UE in a telecommunications system.

FIG. 4 is a diagram illustrating a TD-SCDMA network.

FIG. 5A is a functional block diagram illustrating an adaptive threshold process according to one aspect of the present disclosure.

FIG. 5B is a functional block diagram illustrating channel estimation according to one aspect of the present disclosure.

FIG. 6 is a functional block diagram illustrating channel estimation according to one aspect of the present disclosure.

FIG. 7 is a functional block diagram illustrating example blocks executed to implement one aspect of the present disclosure.

FIG. 8 is a functional block diagram illustrating example blocks executed to implement one aspect of the present disclosure.

FIG. 9 is a functional block diagram illustrating example blocks executed to implement one aspect of the present disclosure.

FIG. 10 is a functional block diagram illustrating example blocks executed to implement one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

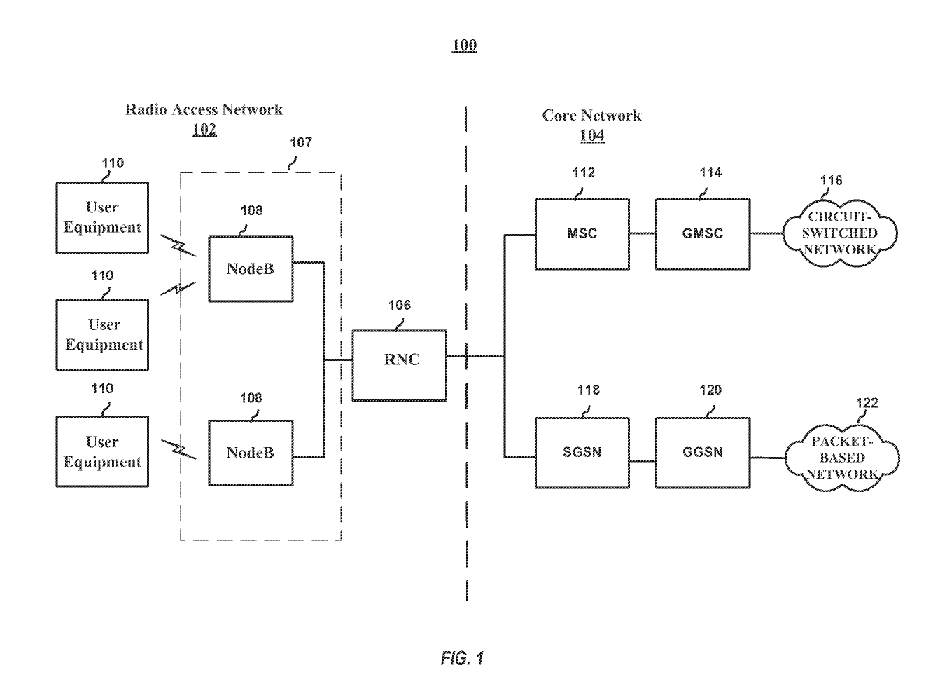

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a tablet computer, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

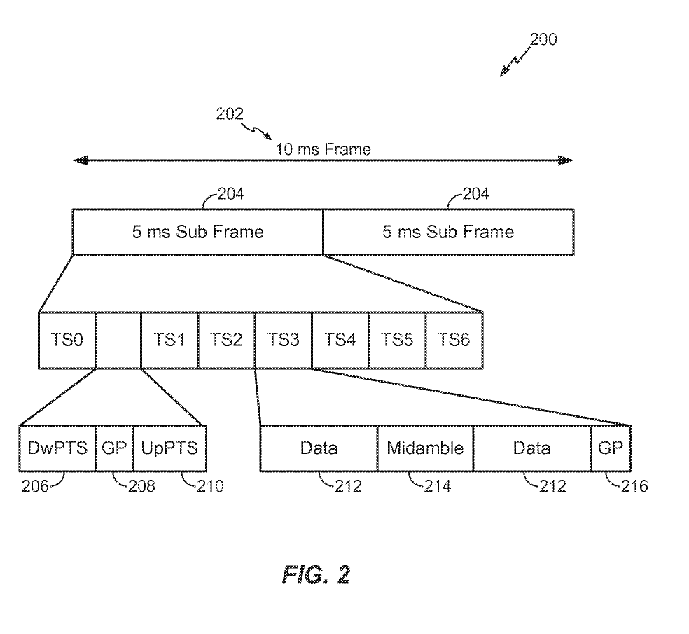

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference. The timing for each downlink time slot in TD-SCDMA is approximately 675 μs or 864 chips. Each chip corresponds to approximately 0.78 μs. The midamble utilizes 144 chips and there are approximately 704 total chips dedicated for data in the combined two data portions 212. Finally, the GP 216 utilizes 16 chips.

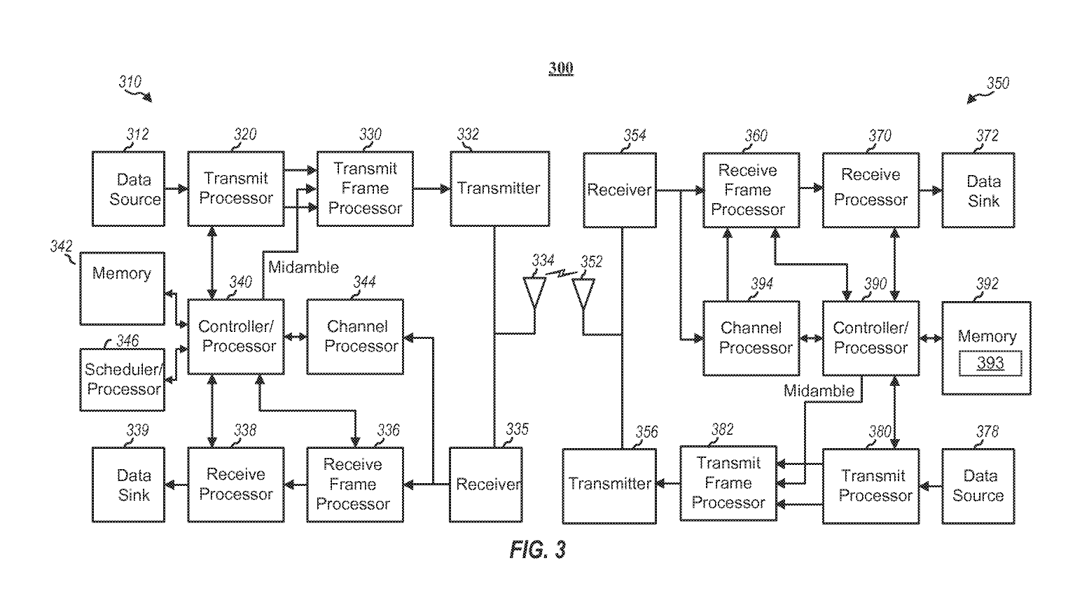

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be transmitted to the Node B 310 for use in selecting the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

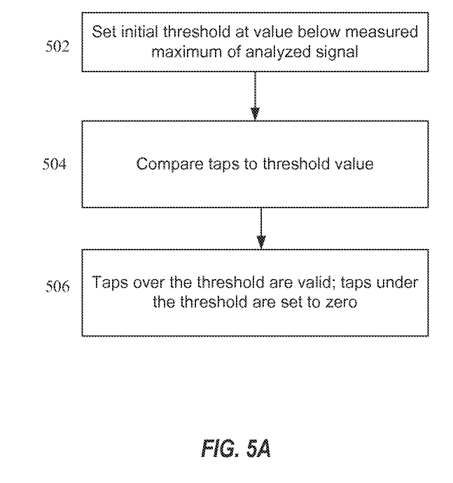

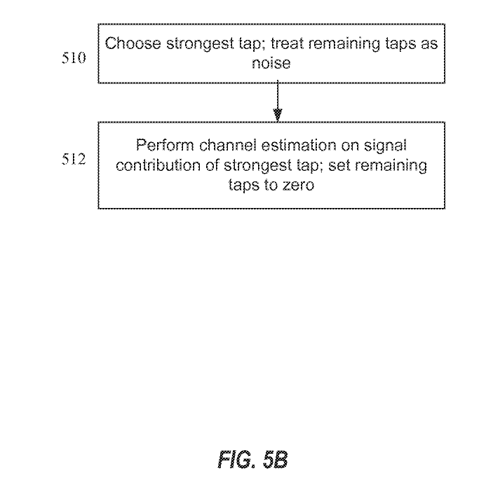

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. For example, the memory 392 of the UE 350 stores linear interference cancellation module 393. When executed by the receive processor 370, the executing linear interference cancellation module 393 configures the UE 350 to perform the interference cancellation functionality as described in the various aspects of the present disclosure, such as, for example, the functional blocks described in FIG. 5. A scheduler/processor 346 at the Node B 310 may be used to allocate resources to the UEs and schedule downlink and/or uplink transmissions for the UEs.

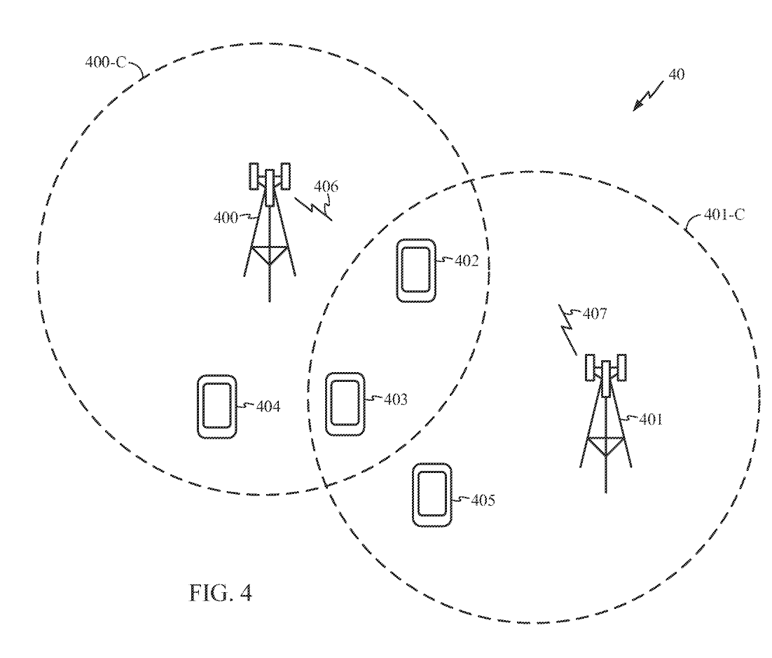

FIG. 4 is a diagram illustrating a TD-SCDMA network 40. While the TD-SCDMA network 40 may include many cells served by many different Node Bs, the illustration presented in FIG. 4, for convenience, shows only two cells 400-C and 401-C served by Node Bs 400 and 401, respectively. A number of UEs, UEs 402-405, are situated in the two cells 400-C and 401-C. In maintaining communication with the various UEs within the cells 400-C and 401-C, the Node Bs 400 and 401 transmit aggregate signals 406 and 407, which include signal components specifically directed or addressed to each individual UE with which communication is maintained. For example, the Node B 400 maintains communication with the UEs 402-404. Therefore, the aggregate signal 406 includes a component directed to the UE 402, another component directed to the UE 403, and another component directed to the UE 404. Similarly, the aggregate signal 407 transmitted by the Node B 401 includes a component directed to the UE 402, another component directed to the UE 403, and another component directed to the UE 405. Each UE will perform channel estimation to differentiate between contributions to the received aggregate signal attributable to each Node B.

According to one aspect of the present disclosure, channel estimations are based on pilot symbols found in a received signal. For example, in a TD-SCDMA communication system, such as the TD-SCDMA network 40, pilot symbols are found in the midamble sequence of a received signal where the midamble sequence is 144 chips in length, and comprises the sum of a 128 chip sequence and 16 cyclic shift chips. In such a system, performing channel estimation should account for 8 cyclic shifts, however in another embodiment, up to 16 potential cyclic shifts may be accounted for. At the UE, exploiting knowledge of these cyclic shifts enables different channel estimations to be performed. However, depending on system parameters, the number of cyclic shifts may vary, and therefore may be less than 8 at a given UE.

To perform channel estimation a UE will first estimate the quality of one or more channels, where a channel may carry an aggregate signal, S, represented by S₁+S₂+S₃+. . . Sₙ, where S₁ represents the signal contribution from a serving Node B and S₂ through Sₙ represent signal contributions from interfering Node Bs. The quality of the channel may be estimated based on the evaluation of one or more metrics associated with that channel including, for example, signal-to-interference-plus-noise ratio (SINR), signal-to-noise ratio (SNR), and the like.

According to an aspect of the present disclosure, a first algorithm or a second algorithm will be selected to perform channel estimation based on the estimated channel quality. If, for example, the channel is determined to be of a low quality (e.g., the evaluated SINR is low), then a first algorithm will be selected. According to one aspect, the first algorithm may be a midamble multiplication-based algorithm. If, on the other hand, the estimated channel quality is determined to be of a high quality (e.g., the evaluated SINR is high), then a second algorithm will be selected. According to another aspect, the second algorithm may be a midamble division algorithm. The determination of whether channel quality is high or low can be based on a number of factors. For example, a channel may be determined to be of high quality when the estimated SINR is above a predefined threshold and may be determined to be of low quality when the estimated SINR is below a predefined threshold.

For a given signal contribution, e.g., S₁, received on a given channel, the signal contribution has a corresponding midamble vector, r̅, which represents the time domain values of the received midamble sequence and can be expressed as the convolution of the midamble sequence and the channel values. The frequency domain response of r̅ is represented by:

y̅=F r̅ (1)

where F is the Fast Fourier Transform (FFT) matrix of the midamble of S₁, which is a 128×128 matrix. In general, deriving the frequency domain response, y̅, is accomplished by applying an FFT operation to the time domain values of the midamble sequence, r̅. The following three equations are known in the art as a least squares (LS) method, generally stated as:

y̅=diag(\tilde{m}₁+diag(\tilde{m}₂)Fh₂+. . . +diag(\tilde{m}_{M})Fh_{N}+ n̅ (2)

where \tilde{m}ᵢ−FD response of Composite Midamble ‘i’ (16, . . . , 128)
F—Fourier Matrix (16×16, . . . , 128×128)
hᵢ—TD channel of midamble ‘i’

$$\overline{y} = MH + \overline{n} where \\ M = [ \begin{matrix}diag ( {\tilde{m}}_{1} ) F & diag ( {\tilde{m}}_{2} ) F & … & diag ( {\tilde{m}}_{N} ) F\end{matrix} ] \\ H = [ \begin{matrix}{h}_{1} \\ {h}_{2} \\ ⋮ \\ {h}_{N}\end{matrix} ] \qquad ( 3 )$$

Ĥ_{LS}=M⁻¹ y̅ (4)

where, M⁻¹ represents pseudo-inverse
With n̅ being additive Gaussian noise, primarily resulting from noise in the antenna of the receiver and residual interferers.

Where the channel quality is estimated to be low, a midamble multiplication-based algorithm is used for channel estimation to first determine:

ŷ= y̅×diag(m₁)* (5)

where ŷ, in this case, represents an element-by-element multiplication of the Fourier transform values of the midamble sequence. As seen, this multiplication is derived by the cross product of the Fourier transform values and the diagonal of conjugate of m₁, which is the diagonal matrix representation of the frequency domain values of the midamble from signal contribution S₁. According to the midamble multiplication method, ŷ is derived by finding the product of y̅ and the diagonal of the conjugate of m₁. The midamble multiplication-based algorithm is beneficial in the case of low channel quality and during the first few iterations because it provides for useful signal gains while avoiding unwanted increases in noise. Because the channel estimation is iterative, at low iterations the effective SINR is lower and hence multiplication can be used.

Following this algorithm, the multiplication values are then converted back into the time domain, i.e., to find \hat{r}, which is the time domain response of ŷ. This is accomplished by finding the product of the Hermitian of the Inverse Fast Fourier Transform and ŷ, and is expressed as:

\hat{r}=F^{H}ŷ (6)

where \hat{r} directly corresponds to the channel estimate for a contribution from a given Node B, which in the case above, is S₁ from the serving Node B. Once \hat{r} is obtained, the UE can determine the signal contribution from the serving Node B.

The midamble multiplication method is carried out in iterative fashion for each remaining signal contribution by first cancelling the S₁ contribution and repeating the steps described above for each of the remaining contributions, i.e., contributions S² through Sₙ. The equation is shown in generalized form as:

ŷ= y̅×diag(mₙ)* (7)

For each of the iterative steps, multiple values of r for each signal contribution are derived and those values are averaged over a given time period. Averaging the values of \hat{r} is desirable in so much as it provides for more accurate channel estimation and negates the effects of spurious results.

Where the channel quality is estimated to be high, a midamble division algorithm is used for channel estimation to first determine:

ŷ= y̅/diag(m₁) (8)

where ŷ, in this case, represents an element-by-element division of the Fourier transform values of the diagonal of the midamble sequence matrix. From above, m₁ is the diagonal matrix representation of the frequency domain values of the midamble from signal contribution S₁. According to the midamble division method, ŷ is derived by dividing y̅ by the diagonal of m₁. This algorithm effectively eliminates midamble sequence values from signal contributions. Using the midamble division algorithm is advantageous in the case of high channel quality because the algorithm is not limited by the auto-correlation of the midamble sequence and is typically useful at higher iterations.

Similar to the discussion above with respect to equation (3), the received midamble vector is then converted back into the time domain. This is again accomplished by finding the product of the Hermitian of the Inverse Fast Fourier Transform and ŷ, and is expressed as:

\hat{r}=F^{H}ŷ (6)

where \hat{r} directly corresponds to the channel estimate for a contribution from a given Node B, which in the case above, is S₁ from the serving Node B.

The midamble division method is carried out in iterative fashion for each remaining signal contribution by first cancelling the S₁ contribution and repeating the steps described above for each of the remaining contributions, i.e., contributions S₂ through Sₙ . The equation is shown in generalized form as:

ŷ= y̅/diag(mₙ) (7)

According to another aspect of the present disclosure, after \hat{r} is derived, whether the midamble multiplication-based algorithm or midamble division algorithm is selected, noise is estimated for at least one channel received at a UE. The estimated noise is then used to adaptively set a threshold. This adaptive threshold is used to further refine the channel estimation process.

A noise estimation is used to adaptively set subsequent threshold values. Specifically, the threshold values can be adaptively set based on the additive white Gaussian noise (AWGN) and/or residual noise from imperfect cancellation of interfering Node Bs. The threshold is “adaptively” set in that it changes during the different iterations described above.

As shown in FIG. 5A, in the adaptive threshold process, an initial threshold is set at a fixed value below the measured maximum value of the signal being analyzed, shown in block 502. The measured value may relate to a number of metrics including, for example, total signal power, peak signal power, noise power, and the like. Taps are compared to the threshold value, as shown in block 504. Taps having a measured value above the initial threshold are valid while taps below that threshold are set to zero, and therefore, have no contribution to the estimation, as shown in block 506.

As shown in FIG. 5B, channel estimation based on estimated noise is accomplished by first choosing the strongest tap and treating the remaining taps as noise, as shown in block 510. This is done under the assumption that the strongest tap is associated with the signal from the serving Node B, in this case S₁. Once the strongest tap is chosen, the operations described above are performed on that signal contribution and all remaining taps are set to zero, as shown in block 512.

During subsequent iterations, previously calculated contributions are removed from the taps being analyzed. By way of example, in a second iteration, the tap associated with S₂ may be analyzed. In this case, the contribution from S₁ would be removed beforehand while weaker taps would be treated as noise and set to zero.

From above, estimating noise during the first iteration is straightforward because all taps other than the strongest tap are treated as noise and set to zero. Accordingly, a threshold can be arbitrarily set during the first iteration. However, during subsequent iterations, noise is calculated by noting the vector associated with subsequent signal taps determined in iteration ‘k−1’ as V_{ST}. This value is calculated to account for AWGN. Afterward, the taps V̅_{ST} are used to determine average noise ( V̅_{ST} rep. complement of the taps) during iteration k.

The adaptive threshold is then expressed as:

Thres(t)=scale(t)×NoisePwr(t) (8)

where t is the iteration number, scale(t) is a scale that changes with each iteration, and NoisePwr is the measured noise power that changes with each iteration. Accordingly, the threshold may be initially set and subsequently changed with each iteration according to empirical data. As seen, there are two variables that affect the adaptive threshold, “scale” and “NoisePwr” each of which vary according to iteration, t. At lower iterations, e.g., t=1, 2, the scale is set to a large value. The scale value decreases as the number of iterations, t, increases. The scale value is based on empirical data and may change according to system parameters.

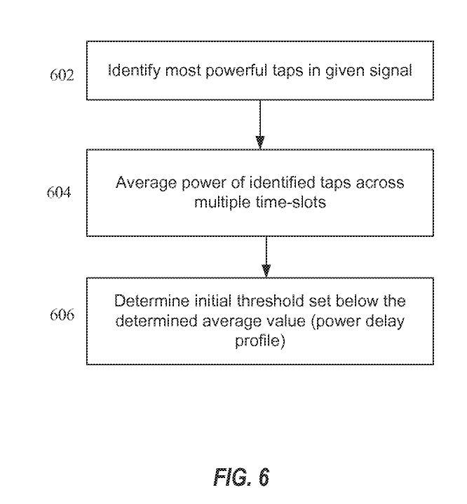

As shown in FIG. 6, according to another aspect of the present disclosure, a delay profile of at least one channel is determined to refine channel estimation. The delay profile may be determined by first identifying the most powerful taps in a given signal, as shown in block 602, and then averaging the power of those taps across multiple time-slots, as shown in block 604. From the determined average value (the “power-delay profile”), an initial threshold may be determined and set below the power-delay profile (e.g., 25 dB below the peak), as shown in block 606. Doing so allows the delay-profile (DP) and power-profile (PP) to be obtained, where the delay-profile is used in TD-SCDMA systems, in one embodiment.

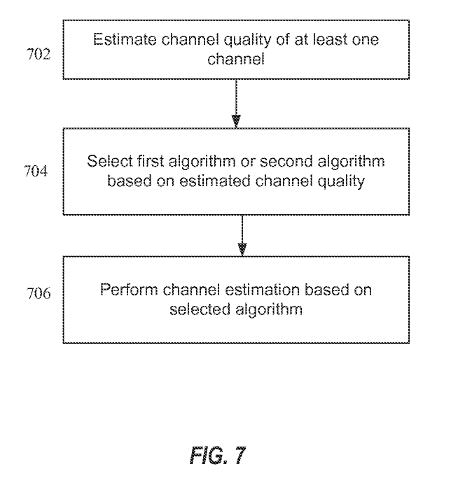

FIG. 7 is a functional block diagram illustrating example blocks executed in conducting wireless communication according to one aspect of the present disclosure. In block 702, channel quality of at least one channel is estimated. Further, at block 704, either a first algorithm or a second algorithm is selected based on the estimated channel quality. Channel estimation is performed based on the selected algorithm at block 706.

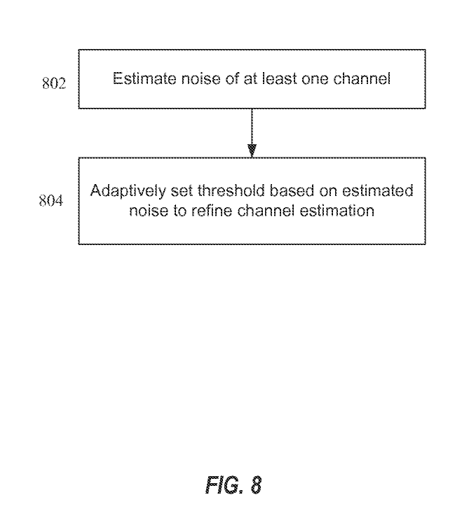

FIG. 8 is a functional block diagram illustrating example blocks executed in conducting wireless communication according to one aspect of the present disclosure. The example blocks of FIG. 8 may be combined with the example blocks of FIG. 7. In block 802, noise is estimated on at least one channel. In block 804, a threshold is adaptively set based on the estimated noise to refine channel estimation.

In one configuration, the UE 350 for wireless communication includes means for estimating channel quality of at least one channel, means for selecting either a first algorithm or a second algorithm, based on the estimated channel quality, and means for performing channel estimation based on the selected algorithm. According to one aspect of the disclosure, the aforementioned means may be the antennas 352, the receiver 354, the channel processor 394, the receive frame processor 360, the receive processor 370, and the controller/processor 390 configured to perform the functions recited by the aforementioned means. In another aspect, the aforementioned means may be a module or any apparatus configured to perform the functions recited by the aforementioned means.

In one configuration, the UE 350 for wireless communication includes means for estimating noise of at least one channel and means for adaptively setting a threshold based on said estimated noise to refine said channel estimation. According to one aspect of the disclosure, the aforementioned means may be the antennas 352, the receiver 354, the channel processor 394, the receive frame processor 360, the receive processor 370, and the controller/processor 390 configured to perform the functions recited by the aforementioned means. In another aspect, the aforementioned means may be a module or any apparatus configured to perform the functions recited by the aforementioned means.

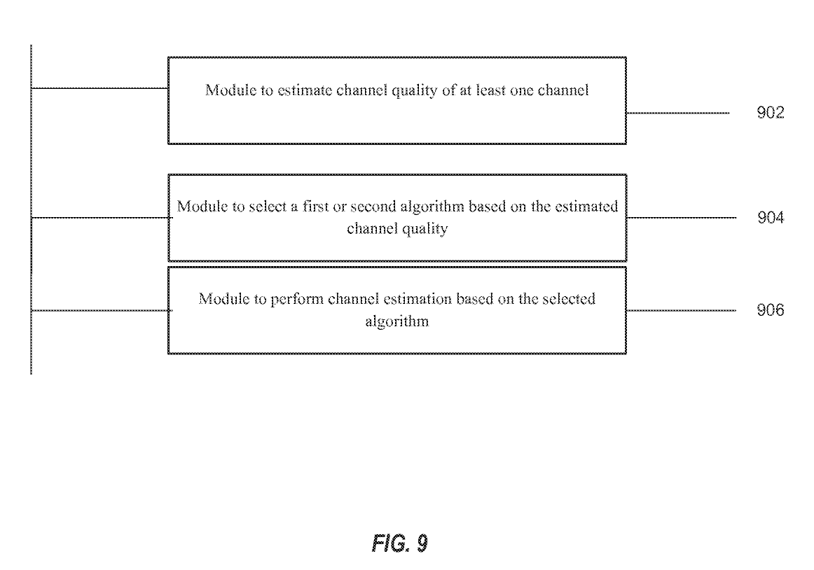

FIG. 9 shows a design of an apparatus for a UE, such as the UE 350 of FIG. 3. The apparatus includes a module 902 for estimating channel quality of at least one channel. The apparatus also includes a module 904 for selecting either a first algorithm or a second algorithm, based on the estimated channel quality. The apparatus further includes a module 906 for performing channel estimation based on the selected algorithm. The modules in FIG. 9 may be processors, electronics devices, hardware devices, electronics components, logical circuits, memories, software codes, firmware codes, etc., or any combination thereof.

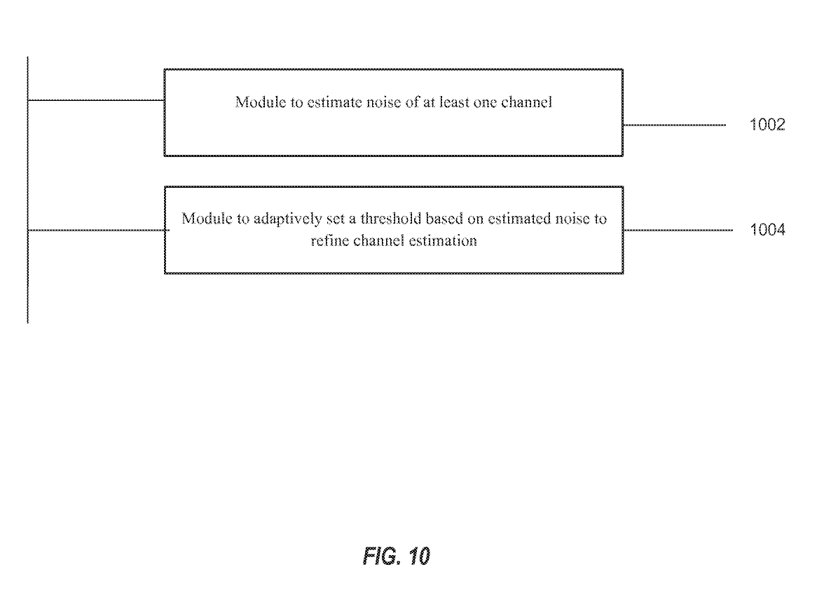

FIG. 10 shows a design of an apparatus for a UE, such as the UE 350 of FIG. 3. The apparatus includes a module 1002 for estimating noise of at least one channel. The apparatus also includes a module 1004 for adaptively setting a threshold based on said estimated noise to refine said channel estimation. The modules in FIG. 10 may be processors, electronics devices, hardware devices, electronics components, logical circuits, memories, software codes, firmware codes, etc., or any combination thereof.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of channel estimation, comprising:
estimating channel quality of at least one channel;
selecting either a first algorithm or a second algorithm, based on the estimated channel quality; and
performing channel estimation based on the selected algorithm.

2. The method of claim 1 wherein said first algorithm comprises a midamble multiplication-based algorithm.

3. The method of claim 1 wherein said second algorithm comprises a midamble division algorithm.

4. The method of claim 1 wherein said channel comprises a Time Division-Synchronous Code Division Multiple Access (TD-SCDMA) channel.

5. The method of claim 1, further comprising:
estimating noise of said at least one channel; and
adaptively setting a threshold based on said estimated noise to refine said channel estimation.

6. The method of claim 5, wherein said estimating channel quality is based on said estimated noise.

7. The method of claim 1, further comprising determining a delay profile of said at least one channel to refine the channel estimation.

8. The method of claim 5 wherein said estimating channel quality, selecting, and performing are iteratively performed for contributing signals on said at least one channel.

9. The method of claim 8 wherein said adaptive threshold is modified across said iterations.

10. A user equipment configured for wireless communication, comprising:
means for estimating channel quality of at least one channel;
means for selecting either a first algorithm or a second algorithm, based on the estimated channel quality; and
means for performing channel estimation based on the selected algorithm.

11. The user equipment of claim 10 wherein said first algorithm comprises a midamble multiplication-based algorithm.

12. The user equipment of claim 10 wherein said second algorithm comprises a midamble division algorithm.

13. The user equipment of claim 10 wherein said channel comprises a Time Division-Synchronous Code Division Multiple Access (TD-SCDMA) channel.

14. The user equipment of claim 10, further comprising:
means for estimating noise of said at least one channel; and
means for adaptively setting a threshold based on said estimated noise to refine said channel estimation.

15. The user equipment of claim 14, wherein said estimating channel quality is based on said estimated noise.

16. The user equipment of claim 10, further comprising means for determining a delay profile of said at least one channel to refine the channel estimation.

17. The user equipment of claim 14 wherein said estimating channel quality, selecting, and performing are iteratively performed for contributing signals on said at least one channel.

18. The user equipment of claim 17 wherein said adaptive threshold is modified across said iterations.

19. A computer program product having a computer readable medium with program code stored thereon, said program code comprising:
program code to estimate channel quality of at least one channel;
program code to select either a first algorithm or a second algorithm, based on the estimated channel quality; and
program code to perform channel estimation based on the selected algorithm.

20. The computer program product of claim 19 wherein said first algorithm comprises a midamble multiplication-based algorithm.

21. The computer program product of claim 19 wherein said second algorithm comprises a midamble division algorithm.

22. The computer program product of claim 19 wherein said channel comprises a Time Division-Synchronous Code Division Multiple Access (TD-SCDMA) channel.

23. The computer program product of claim 19, wherein said program code further comprises:
program code to estimate noise of said at least one channel; and
program code to adaptively set a threshold based on said estimated noise to refine said channel estimation.

24. The computer program product of claim 23, wherein said program code to estimate channel quality estimates said channel quality based on said estimated noise.

25. The computer program product of claim 19, further comprising program code to determine a delay profile of said at least one channel to refine the channel estimation.

26. The computer program product of claim 23 wherein said program code to estimate channel quality, program code to select, and said program code to perform are iteratively executed for contributing signals on said at least one channel.

27. The computer program product of claim 26 wherein said adaptive threshold is modified across said iterations.

28. A user equipment for wireless communication, comprising:
at least one processor; and
a memory coupled to said at least one processor,
wherein said at least one processor is configured:
to estimate channel quality of at least one channel;
to select either a first algorithm or a second algorithm, based on the estimated channel quality; and
to perform channel estimation based on the selected algorithm.

29. The user equipment of claim 28 wherein said first algorithm comprises a midamble multiplication-based algorithm.

30. The user equipment of claim 28 wherein said second algorithm comprises a midamble division algorithm.

31. The user equipment of claim 28 wherein said channel comprises a Time Division-Synchronous Code Division Multiple Access (TD-SCDMA) channel.

32. The user equipment of claim 28, wherein the at least one processor is further configured:
to estimate noise of said at least one channel; and
to adaptively set a threshold based on said estimated noise to refine said channel estimation.

33. The user equipment of claim 32, wherein the estimation of channel quality is based on said estimated noise.

34. The user equipment of claim 28, wherein the at least one processor is further configured to determine a delay profile of said at least one channel to refine the channel estimation.

35. The user equipment of claim 32 wherein the estimation of channel quality, the selection, and the performing are iteratively performed for contributing signals on said at least one channel.

36. The user equipment of claim 35 wherein said adaptive threshold is modified across said iterations.
